(19) United States
(12) Patent Application Publication
(10) Pub. No.: US 2010/0141463 A1
(43) Pub. Date: Jun. 10, 2010

(54) PROVIDING PRICE AND SERVICE INFORMATION TO ELECTRIC POWER CUSTOMERS

(75) Inventor: Edmund O. Schweitzer, III, Pullman, WA (US)

Correspondence Address: Schweitzer Engineering Laboratories, Inc.;Richard Edge, 2350 NE HOPKINS COURT, PULLMAN, WA, 99163-5603, US

(73) Assignee: Schweitzer Engineering Laboratories, Inc.

(21) Appl. No.: 12/331,600

(22) Filed: Dec. 10, 2008

(51) Int. Cl. G08B 21/00; G06F 1/26; G06F 1/32

(52) U.S. Cl. 340/658; 700/286; 700/295; 700/297

(57) ABSTRACT

A notification device and method associated therewith for notifying an electric power consumer to reduce electric power consumption when the notification device detects selected power system conditions. The notification device detects conditions on the electric power system that would likely be alleviated by a reduction in consumer power consumption and provides a visual and/or audible notification to the consumer accordingly. The condition may be indicative of strains on the electric power system and/or higher cost of electricity distributed to the consumer. The condition may be induced by the electric power utility. The notification device and method disclosed herein allow the consumer to decide whether to reduce power consumption as is practical for the consumer.

### RELATED APPLICATION

None

### TECHNICAL FIELD

This disclosure relates to communicating electric power system information to customers. More particularly, this disclosure relates to systems and methods for notifying customers of certain power system conditions so that customers can make informed power consumption decisions so as to avoid higher electric power prices and/or interrupted electric power delivery.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a block diagram of the system and apparatus of the present disclosure as used in an electric power system;

FIG. 2 illustrates a simplified block diagram of a notification device incorporated into the system of FIG. 1;

FIG. 3 illustrates a simplified functional block diagram of the processor of the notification device of FIG. 2;

FIG. 4 illustrates another simplified functional block diagram of the processor of the notification device;

FIGS. 5A, 5B, 5C, and 5D illustrate logic diagrams of various functions and components of the notification device;

FIG. 6 illustrates a flow diagram of a method in accordance with the present disclosure; and,

FIG. 7 illustrates another flow diagram of a method in accordance with the present disclosure.

### DETAILED DESCRIPTION

I. Overview

The consumption of electric power by consumers often plays a significant role in the stability of an electric power distribution system. The present disclosure provides an apparatus, system, and method that, based on the fundamentals of the electric power system, signals consumers to modify their electric power consumption. By reducing power consumption, the customer may receive the benefit of fewer interruptions in power delivery and/or reduced cost during times of high load on the electric power system. The systems, methods, and apparatus disclosed can be used to alleviate certain electric power distribution system strains such as deviations in frequency and changes in voltage. The systems, methods, and apparatus disclosed can also be used by the consumer to avoid certain uses of electric power during periods of heavy usage (often correlated with higher cost of electric power). Further, the electric power utility can use the disclosed systems, methods, and apparatus to signal to consumers by inducing certain power system conditions that would trigger the apparatus disclosed herein. Thus the systems, methods, and apparatus disclosed herein alert the customer to reduce electric power consumption, where not doing so may result in higher costs and/or interruptions in electric power delivery to the consumer

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments described will be illustrated as software functions or components. As used herein, a software function or component may include any type of computer instruction or computer executable code located within a memory device and/or transmitted as electronic signals over a system bus or wired or wireless network. A software function or component may, for instance, comprise one or more physical or logical blocks of computer instructions, which may be organized as a routine, program, object, component, data structure, etc., that performs one or more tasks or implements particular abstract data types.

In certain embodiments, a particular software function or component may comprise disparate instructions stored in different locations of a memory device, which together implement the described functionality of the function. Indeed, a function or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software functions or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

II. Electric Power Distribution

Typical electric power distribution systems contain several pieces of power system equipment designed to distribute the electric power from a source to a consumer. The equipment typically includes conductors (overhead as well as underground), transformers, generators, capacitor banks, voltage regulators, circuit breakers, reclosers, fuses, and the like. Often, electric power distribution systems are fed by electric power transmission systems that transmit higher-voltage electric power from a generating station. Electric power demand has required operation of existing electric power transmission and distribution systems at their limits. Due to several political and economic concerns, new transmission and distribution equipment is difficult to implement even though it would ease the burden on existing transmission and distribution systems.

Increasing demand on existing power transmission and distribution systems sometimes causes failures. One example is the Northeast Blackout of 2003, where the overburdened electric power systems failed. Consumer units drawing electric power from the electric power system are a significant factor in overburdening the power system. Reducing consumer power consumption may have a significant impact on reducing the burden on an electric power system, particularly during periods of peak usage.

The present disclosure provides a solution to the problem of overburdened electric power systems by notifying consumers of power system conditions such that the consumer has the option of changing power consumption. This solution avoids the Orwellian implications of an electric power utility controlling power consumption by switching off certain consumer units. Attempts have been made by several entities to empower an electric power utility to switch off or reduce the power consumption by particular consumner units of particular electric power consumers automatically. For example, the utility may have a load management system by which it places a load switch on a consumer unit (such as an air conditioner, a water heater, or the like). When the load switch receives a communication from the electric power utility, it causes a reduction or elimination in the power consumed by that unit. Further, the power management system can be configured to raise thermostat levels during the warm season, switch off swimming pool circulation pumps, delay starting times of dishwashers, and the like. Of course, without the proper electric power, the consumer unit often does not provide the desired benefits to the consumer.

These load switches may be signaled by the electric power utility using a carrier imposed on the power line. Alternatively, a conventional means of communication with the load switch may be used such as satellite, radio, telephone lines, the Internet, and the like.

Further, such load management systems may operate based on a time of day. In certain electric power distribution systems the cost of electricity changes based on the time of day. A load switch connected to certain consumer units may decrease (or eliminate) electric power usage by the unit during certain times of day. By thus reducing power consumption, the total cost of electric power is decreased for the consumer and the peak loading conditions are likely decreased for the electric power utility.

Electric power systems are designed to provide electric power within tight operating parameters for frequency and voltage. For example, electric power systems typically operate at “nominal frequency”, which is 60 Hz in the United States, and 50 Hz in Europe. Electric power is typically provided to the consumer at around 120V in the United States and 230V in Europe. Electric power systems undergo continuous changes such as loads and generation switching on and off, voltage regulators and capacitor banks operating, and the like. Due to the various changes, the electric power system is forced to maintain nominal voltage and frequency levels. Such compensation typically results in a stable condition. However, severe disturbances or disturbances when the load approaches or exceeds generation may result in unstable conditions such as a depressed voltage, frequency deviations, power swings, extreme conditions, brown-outs, blackouts, and the like. During these abnormal operating conditions on the electric power system, frequency and voltage values may fall outside of the nominal operating ranges. If the unstable condition is allowed to persist, or further aggravating factors are introduced, the electric power system may begin to shed loads (upon instruction to do so), or even collapse, resulting in loss of power to consumers. Reducing load to match generation on the electric power system during an abnormal operating condition may serve to improve the situation and restore the electric power system to its safe operating parameters and thereby provide the most electrical service to the maximum number of people.

III. Power System Condition Notification Device

The apparatus disclosed herein functions to give electric power consumers notice of a power system condition where decrease in electric power consumption should be advantageous for the electric power system, and operates according to the power system conditions instead of by direct communication from the power utility or time-of-day. Thus, the consumer may decide and act to reduce power consumption based on notifications received from the apparatus described herein.

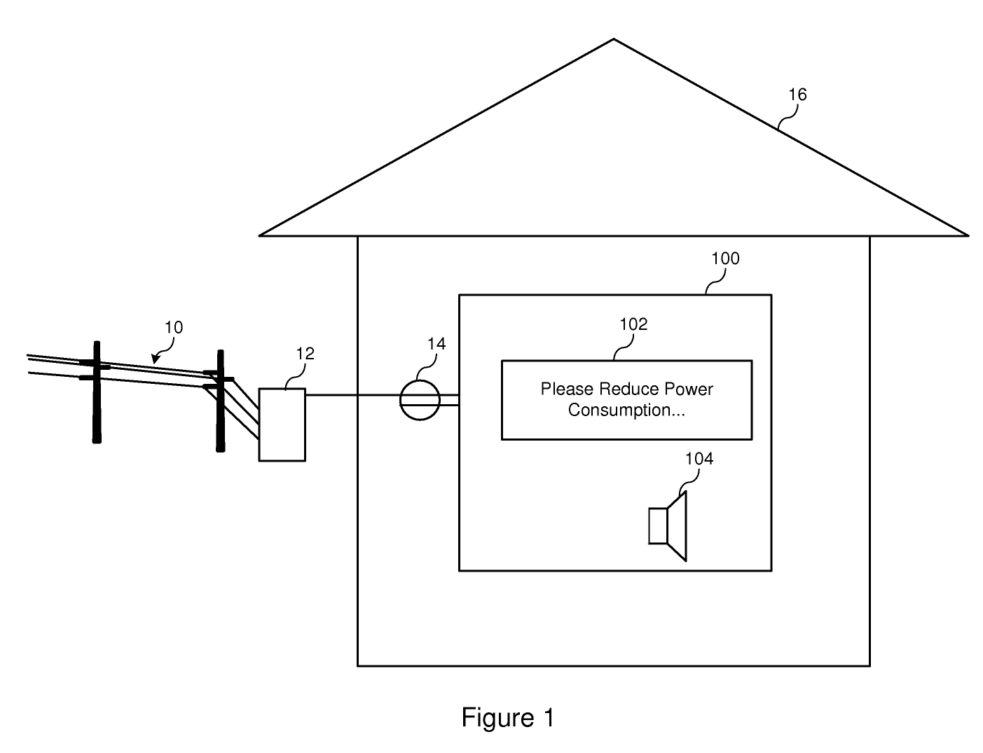

FIG. 1 illustrates a block diagram of the notification device of the present disclosure. As has been described, an electric power distribution system 10 is provided to deliver electric power to consumers. The electric power distribution system 10 includes three phases, all or any of which may be connected to a step-down transformer 12 that is configured to step the voltage down to an acceptable level for use by a consumer. A conductor from the step-down transformer connects one phase of the electric power system to a consumer via a connection to a building or home 16 of the consumer.

The home or building 16 of the consumer may include various power outlets 14 (such as those commonly found in a house or building) for connection to the electric power system. The notification device 100 of the present disclosure connects to the electric power system via a power outlet 14. The notification device 100 samples the electric power of the electric power system 10 present through the outlet 14. The notification device 100 uses the sampled electric power data to determine whether it should notify a consumer of a recommended action. For example, if the notification device 100 detects a reduction in voltage of a sufficient magnitude, then it can be configured to notify the consumer. Some examples of power system conditions that may be detected by the notification device 100 and that would trigger notification includes voltage out of range, change in voltage, rate of change of voltage, frequency out of range, change in frequency, rate of change of frequency, and combinations thereof.

The notification device may be configured to detect and give notification upon detection of certain power system conditions that may be improved by a reduction in the load on the electric power system. Thus, the notification device may be configured to provide notifications to the consumer to alert the consumer to reduce the power consumed. The consumer is ultimately responsible to make the decision to reduce power consumption by reducing use of units such as water heaters, air conditioners, cooking devices, and the like.

To provide the notification, the notification device 100 may include a display 102 such as a liquid crystal display (“LCD”) for displaying a message such as “Please Reduce Power Consumption” or the like. The notification device 100 may also include a sound-emitting component such as a sounder or a speaker 104 used to give an audible alert to the consumer to reduce power consumption. The sound-emitting component 104 may notify using sounds and/or speech. Further, the notification device 100 can be configured to give different notifications depending on the type of power system condition detected, the severity of the power system condition detected, and/or the length of time that the power system condition has been present.

For example, if the notification device 100 detects that the voltage has dropped below a predetermined level, it may display “Please Reduce Power Consumption” on the display 102 and give a short chirp sound from the speaker 104. If the voltage then drops below another threshold, the display may flash and/or display a different message, and the speaker 104 may speak “Please Reduce Power Consumption” and repeat such. Further, if the voltage level remains below a threshold, the display 102 and/or speaker 104 may indicate the amount of time that the power system condition has persisted. The notifications displayed and/or spoken may include a code corresponding to the type of power system condition detected. The code may be words indicating the power system condition such as “frequency out of range” or “drop in voltage” or the like, or the code may comprise status-indicating letters and/or numbers such as “condition 1A” or “alert 2C” or the like.

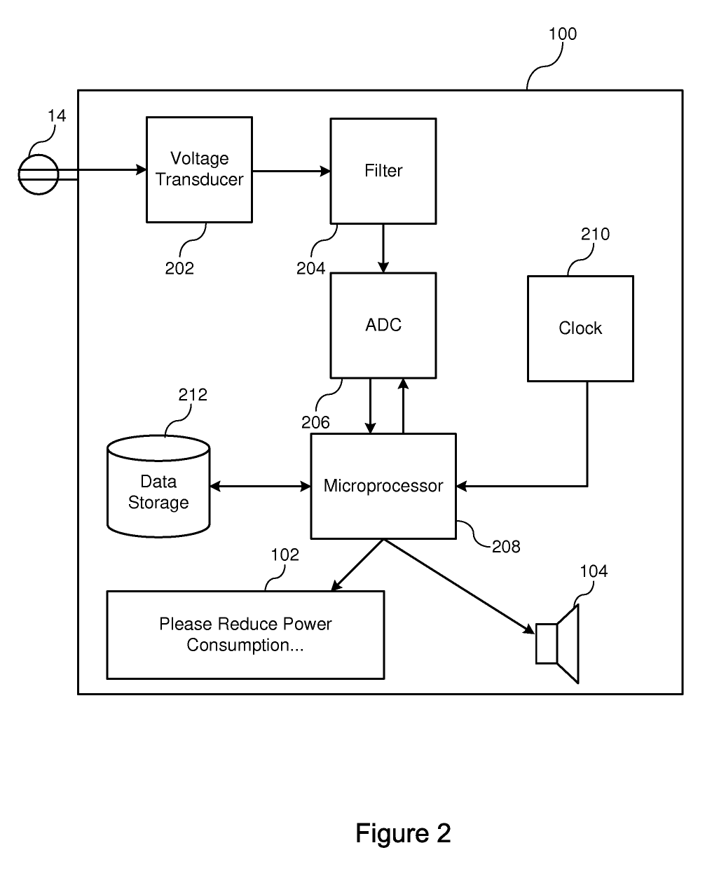

FIG. 2 illustrates a functional block diagram of the notification device 100 of the present disclosure. The notification device 100 includes an acquisition circuit to obtain power system samples from the electric power system via power outlet 14. To determine whether (and which) notification should be made, the notification device 100 includes various components for detecting power system conditions and making the notification.

In particular, the notification device 100 includes a voltage transducer 202 for converting the analog voltage from the power outlet 14 to a signal acceptable to the analog-to-digital converter (“ADC”) 206. The signal from the voltage converter 202 may pass through a low pass filter 204 to eliminate high frequency components for the purpose of anti-aliasing. The filtered signal is fed to the ADC 206 for conversion to a digital signal, which is then fed to a processing unit such as a microprocessor, field programmable gate array (“FPGA”), application specific integrated circuit (“ASIC”) or the like, referred to herein as a microprocessor 208. The microprocessor 208 runs predefined algorithms to determine the power system condition. If the power system condition warrants a notification to the consumer, the microprocessor 208 generates a signal for application to display 102 and/or the speaker 104 and causes a notification to be given. The display 102 and or the speaker 104 then give the notification.

The notification device 100 further includes a clock 210 that may either be part of the microprocessor, or a stand-alone clock. The clock 210 provides a timing signal to the microprocessor 208. The microprocessor 208 may use the timing signal to control the ADC 206.

The notification device 100 also includes a data storage unit 212 in communication with microprocessor 208 and configured to store information in a computer-readable format. The data storage unit 212 may be any of the various data storage devices known such as, for example, a hard drive, a floppy diskette, an optical disk, a CD-R, a DVD-R, RAM, EPROM, EEPROM, a magnetic or optical card, a solid-state memory device, or the like. The data storage unit 212 may include computer instructions for operation of microprocessor 208function. The data storage unit 212 may further include thresholds used by the microprocessor 208. The data storage unit 212 may further be configured to store data provided thereto by the microprocessor 208, and the various notifications that may be given.

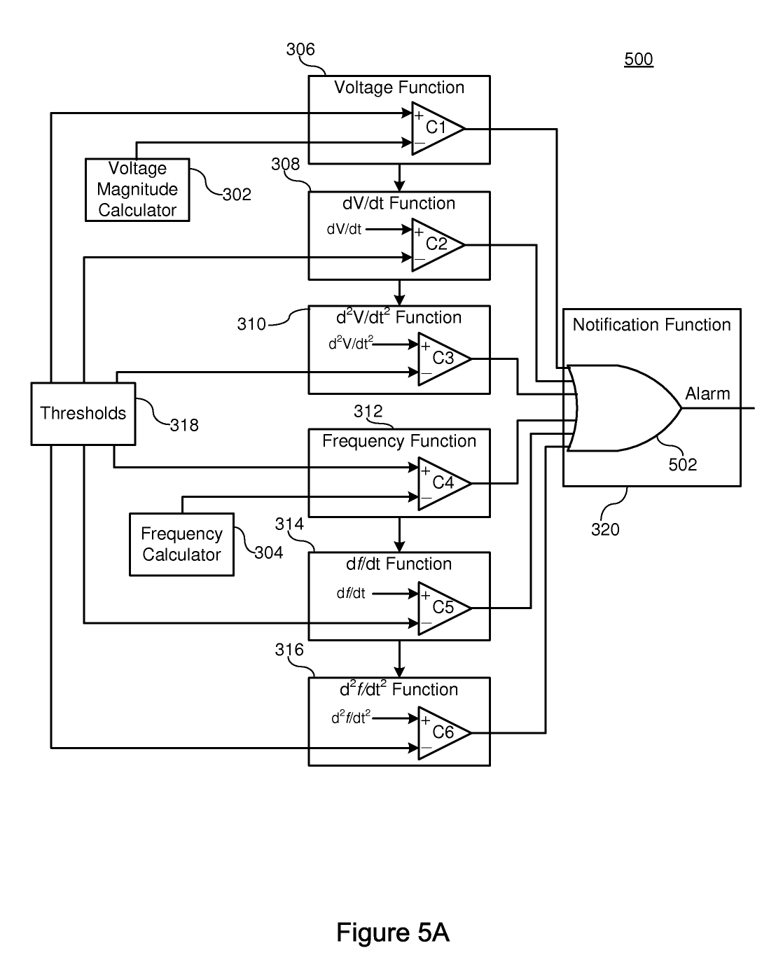

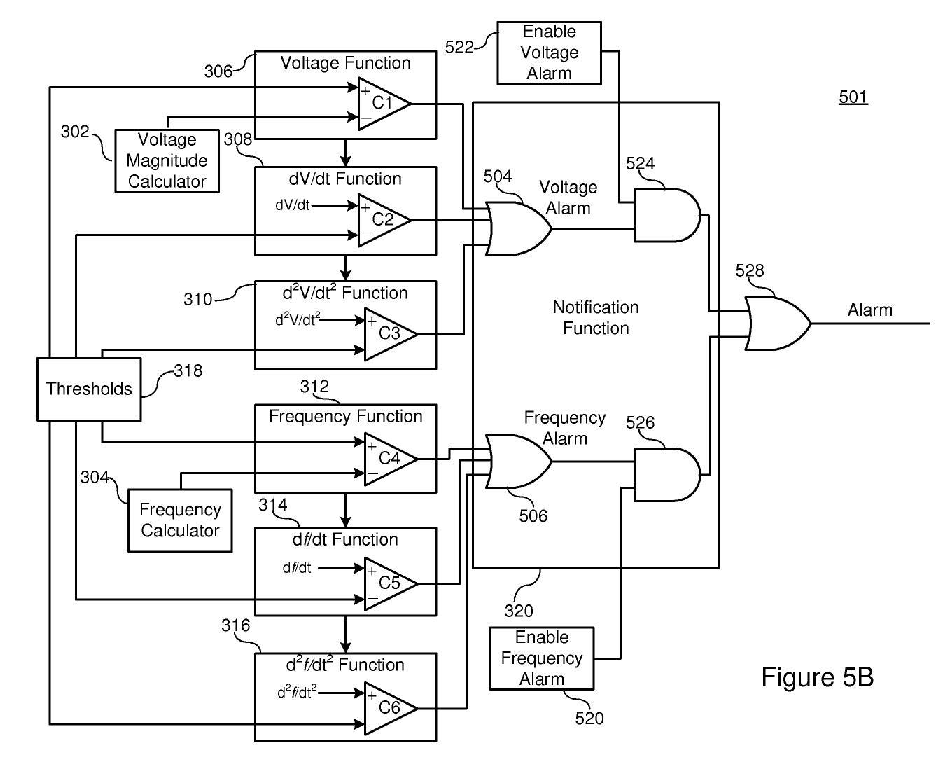

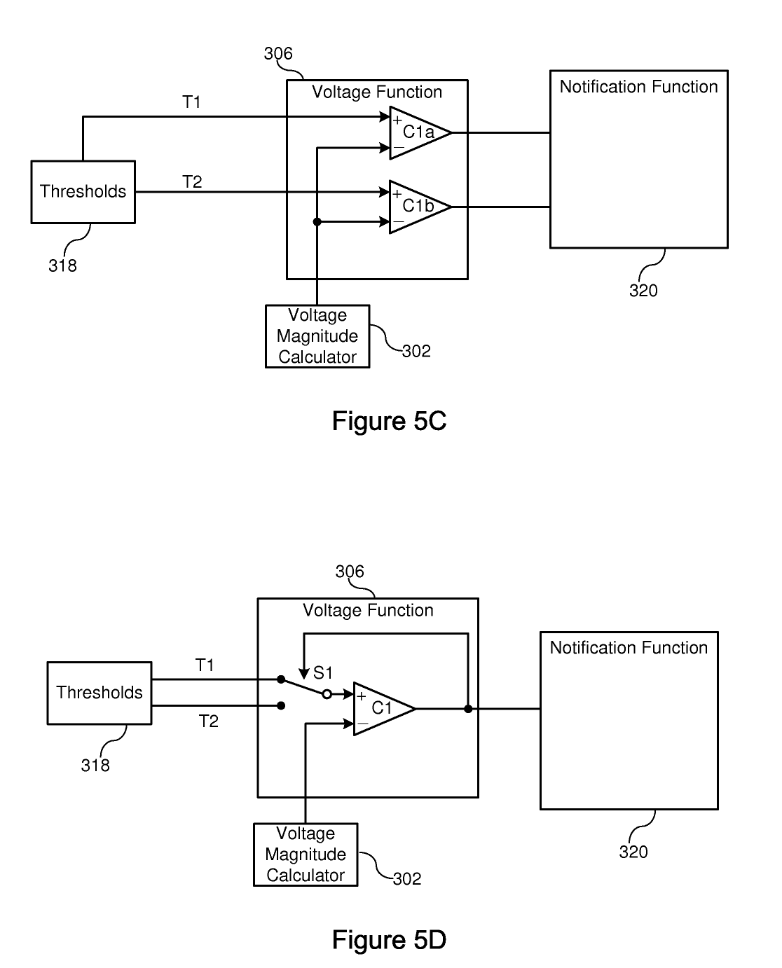

Microprocessor 208 may execute one or more predetermined algorithms to determine the presence of a power system condition that could potentially be alleviated by reduced load. One function that the microprocessor 208 may execute is to compare the voltage magnitude calculated by the voltage magnitude calculator 302. The voltage magnitude calculator 302 first determines a value for voltage that can be compared against a voltage magnitude threshold. For example, the function may calculate voltage magnitude by determining the root mean square (RMS) voltage on an AC power system over a predetermined amount of time, number of samples, or number of cycles. Alternatively, the voltage magnitude may be calculated using the fundamental component of the power system operating frequency, i.e., 50 Hz for most areas outside of the United States, and 60 Hz for the United States. The voltage function may then compare the voltage magnitude (“V”) to threshold values to determine whether the power system voltage V is above or below an operating threshold. If the voltage V falls below a threshold, the voltage function provides a signal indicating a drop in power system voltage. The function may compare the voltage V against several thresholds and modify the signal depending on the threshold below which the voltage V falls. For example, if one threshold is 118 V and another is 117 V and the measured voltage V is 117.5, then the signal will indicate an initial drop in voltage. Where the measured voltage V is 116, the signal will indicate a serious drop in voltage. The signal is used to determine which notification message to enable. This is further described in conjunction with FIGS. 5C and 5D, below.

Thresholds may be provided from a number of different sources. The thresholds may be settings provided by the manufacturer or provider of the notification device 100. In one embodiment thresholds may be set and/or changed by an end user of the notification device 100. In one embodiment, thresholds may be calculated by the notification device 100 based on past measurements made by the notification device 100.

Another function that microprocessor 208 may execute is a

$$\frac{d V}{d t}$$

Function that calculates the change in voltage over time. This function is similar to the previously described voltage function in that

$$\frac{d V}{d t}$$

is determined and compared against a threshold value. For example, the

$$\frac{d V}{d t}$$

function may calculate the change in voltage over time according to equation 1:

$$\frac{d V}{d t} = \frac{\vert {V}_{t} - {V}_{t - Δ t} \vert}{Δ t} \qquad ( 1 )$$

where Vₜ is the value of V at time t and V_{(t-Δt)} is the value of V at time t−Δt. The change in voltage over time

$$\frac{d V}{d t}$$

is then compared against predetermined thresholds to determine whether a signal should be generated, and ultimately which notification should be made.

Another voltage-based function that may be executed by microprocessor 208 is a rate-of-change-of-voltage

$$\frac{d {}^{2} V}{d {t}^{2}}$$

function which calculates a rate of change of voltage. With this function

$$\frac{d V}{d t}$$

values are first determined (or obtained from the

$$\frac{d V}{d t}$$

function) and the second derivative is calculated using the present and past values of

$$\frac{d V}{d t} .$$

Any method for calculating the second derivative may be used. For example, the derivative of the rate of change of voltage V over time may be calculated and used as the second derivative. Alternatively, the

$$\frac{d {}^{2} V}{d {t}^{2}}$$

function may use a three-point method of calculating the second derivative. One method for calculating

$$\frac{d {}^{2} V}{d {t}^{2}}$$

is further described in equation 2:

$$\frac{{d}^{2} V}{d {t}^{2}} = \frac{\vert \frac{d V}{d {t}_{t}} - \frac{d V}{d {t}_{t - Δ t}} \vert}{Δ t} \qquad ( 2 )$$

where

$$\frac{d V}{d {t}_{t}}$$

is the

$$\frac{d V}{d t}$$

value at time t,

$$\frac{d V}{d {t}_{t - Δ t}}$$

is the

$$\frac{d V}{d t}$$

value at time t−Δt. The value of

$$\frac{{d}^{2} V}{d {t}^{2}}$$

is then compared against one or more thresholds to determine whether a signal should be given and ultimately which notification signal should be used.

Another function that may be executed by the microprocessor 208 is a frequency function that is configured to use the frequency of the electric power system as calculated by the frequency calculator, and compare the frequency against one or more thresholds to determine whether notification should be given. The frequency calculator can function according to any of a range of methods for calculating frequency from a sampled signal. For example, the frequency calculator can include a zero-crossing detector, which detects when the signal crosses zero. The frequency calculator may use the zero-crossing detector in conjunction with a signal from the clock to determine the time between zero-crossings, and use this time to determine the frequency of the signal. Or the frequency calculator can instead count the number of zero crossings within a certain time period, using this number and the time passed to determine the frequency. The frequency can be determined using any of the several methods of calculating frequency that are well known in the art. As with the voltage function, the frequency function compares the calculated frequency against one or more thresholds to determine if and/or which notification should be given.

Yet another function that may be executed on the microprocessor is a

$$\frac{d f}{d t}$$

function, which calculates the change-in-frequency over time and compares the calculated

$$\frac{d f}{d t}$$

value against one or more thresholds. The

$$\frac{d f}{d t}$$

value may be determined using Equation 3:

$$\frac{d f}{d t} = \frac{\vert {f}_{t} - {f}_{t - Δ t} \vert}{Δ t} \qquad ( 3 )$$

where fₜ is the calculated frequency at time t and f_{t-Δt} is the calculated frequency at time t−Δt. The frequencies used may be calculated using any of the methods described above. The

$$\frac{d f}{d t}$$

value is then compared against one or more thresholds to determine if and/or which notification should be given.

Another function that may be executed on the microprocessor is the rate-of-change-of-frequency function, which is configured to calculate a rate of change of frequency

$$( \frac{{d}^{2} f}{d {t}^{2}} )$$

value and compare the

$$\frac{{d}^{2} f}{d {t}^{2}}$$

value against predetermined or generated thresholds. The

$$\frac{{d}^{2} f}{d {t}^{2}}$$

value may be calculated according to any known method, including, for example, the method of Equation 4:

$$\frac{{d}^{2} V}{d {t}^{2}} = \frac{\vert \frac{d f}{d {t}_{t}} - \frac{d f}{d {t}_{t - Δ t}} \vert}{Δ {t}^{2}} \qquad ( 4 )$$

where

$$\frac{d f}{d {t}_{t}}$$

is the calculated frequency at time t,

$$\frac{d f}{d {t}_{t - Δ t}}$$

is the calculated frequency at time t−Δt1. The calculated

$$\frac{d {}^{2} f}{d {t}^{2}}$$

value is compared against one or more thresholds to determine whether and/or which notification should be given.

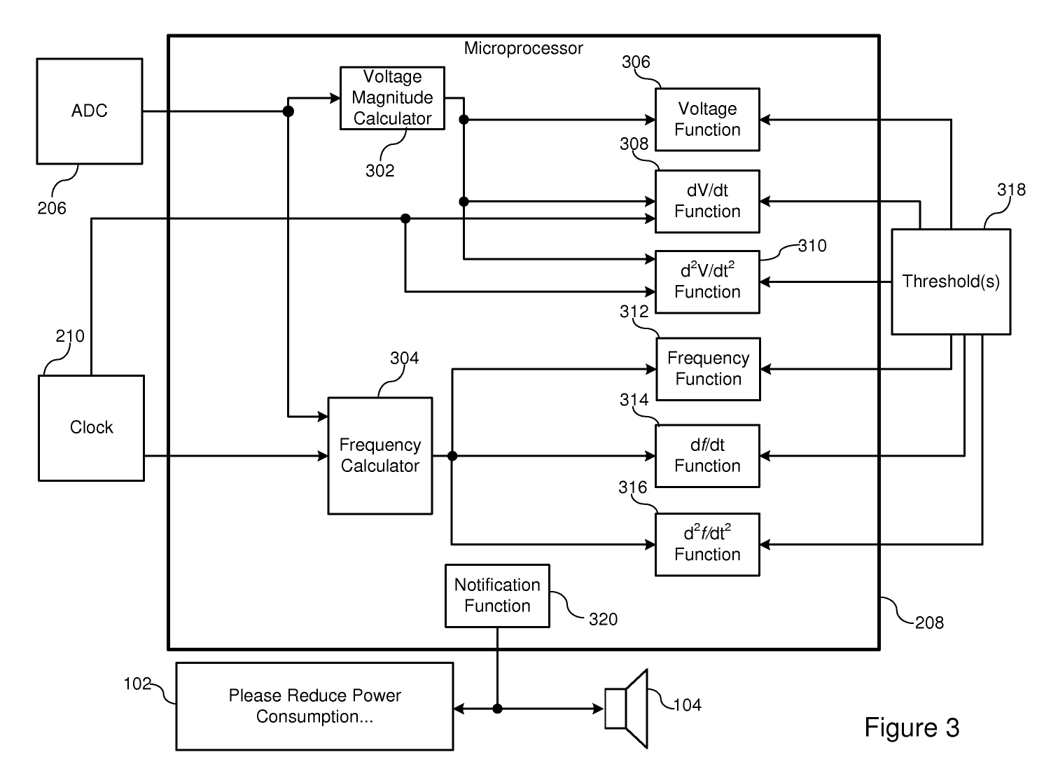

As has been noted above, one or more functions may be executed by the microprocessor to determine whether and/or which notification should be given. FIG. 3 illustrates a functional block diagram of the functions operating on the microprocessor 208. Several voltage and frequency functions (Voltage Function 306, the

$$\frac{d V}{d t}$$

### Function 308, the

$$\frac{d {}^{2} V}{d {t}^{2}}$$

### Function 310, the Frequency Function 312, the

$$\frac{d f}{d t}$$

### Function 314, and the

$$\frac{d {}^{2} f}{d {t}^{2}}$$

Function 316) operate to calculate a power system condition and compare that condition against a threshold to determine whether a particular notification needs to be given.

As indicated above, the samples from the ADC 206 are made available to the voltage magnitude calculator 302, which calculates values of V. The calculated V values are available to the Voltage Function 306, the

$$\frac{d V}{d t}$$

### Function 308 and the

$$\frac{d {}^{2} V}{d {t}^{2}}$$

Function 310. Threshold values from the Threshold function 318 are also made available to the Voltage Function 306, the

$$\frac{d V}{d t}$$

### Function 308 and the

$$\frac{d {}^{2} V}{d {t}^{2}}$$

Function 310. Further, a time signal from the Clock 210 is made available to the

$$\frac{d V}{d t} and \frac{d {}^{2} V}{d {t}^{2}}$$

Functions 308, 310. Alternatively, where the time between samples is even and constant, the

$$\frac{d V}{d t} and \frac{d {}^{2} V}{d {t}^{2}}$$

Functions 308, 310 may not need a signal from the clock, but instead may use the predetermined value of At. Further the clock signal may be available from either the clock 210 or the microprocessor 208. The Voltage Function 306, the

$$\frac{d V}{d t}$$

### Function 308 and the

$$\frac{d {}^{2} V}{d {t}^{2}}$$

Function 310 operate according to the disclosure of each detailed above to enable the Notification Function 320, which is executed to control the display 102 and/or the speaker 104 to give appropriate notification to the consumer.

The frequency calculator 304 calculates a frequency of the electric power system from the samples made available from the ADC 206 and a time signal from the clock 210. Again where the samples are taken at predetermined time intervals (even and constant), the frequency calculator 304 may use the predetermined value of Δt instead of a time signal that may be provided by the clock 210 or microprocessor 208. also, a time signal may be available from the frequency calculator 304. The frequency calculator 304 operates as disclosed hereinabove. Calculated frequencies from the frequency calculator 304 are then made available to the Frequency Function 312, the

$$\frac{d f}{d t}$$

### Function 314, and the

$$\frac{{d}^{2} f}{d {t}^{2}}$$

Function 316. The various functions 314, 316 may further receive a time signal from the Clock 210 (via, for example, the frequency calculator 304). Again where the samples are taken at predetermined time intervals (even and constant), the various functions 314, 316 may use the predetermined value of Δt instead of a time signal that may be provided by the clock 210 or microprocessor 208. Each of the Frequency Function 312, the

$$\frac{d f}{d t}$$

### Function 314, and the

$$\frac{{d}^{2} f}{d {t}^{2}}$$

Function 316 can access threshold inputs from the Threshold Function 318. Accordingly, each of the Frequency Function 312, the

$$\frac{d f}{d t}$$

### Function 314, and the

$$\frac{{d}^{2} f}{d {t}^{2}}$$

Function 316 operates according to the principles disclosed above to determine if and/or which notification should be given by enabling the Notification Function 320, which is executed to control the display 102 and/or the speaker 104 to give appropriate notification to the consumer.

The embodiment of the disclosed invention illustrated in FIG. 3 allows for one, several, or all of the various voltage and frequency functions to operate independently because none of the voltage or frequency functions depend on the operation of the other voltage or frequency functions. Thus, the notification device 100 may operate using, for example, only the

$$\frac{{d}^{2} f}{d {t}^{2}}$$

Function 316 without using the other functions.

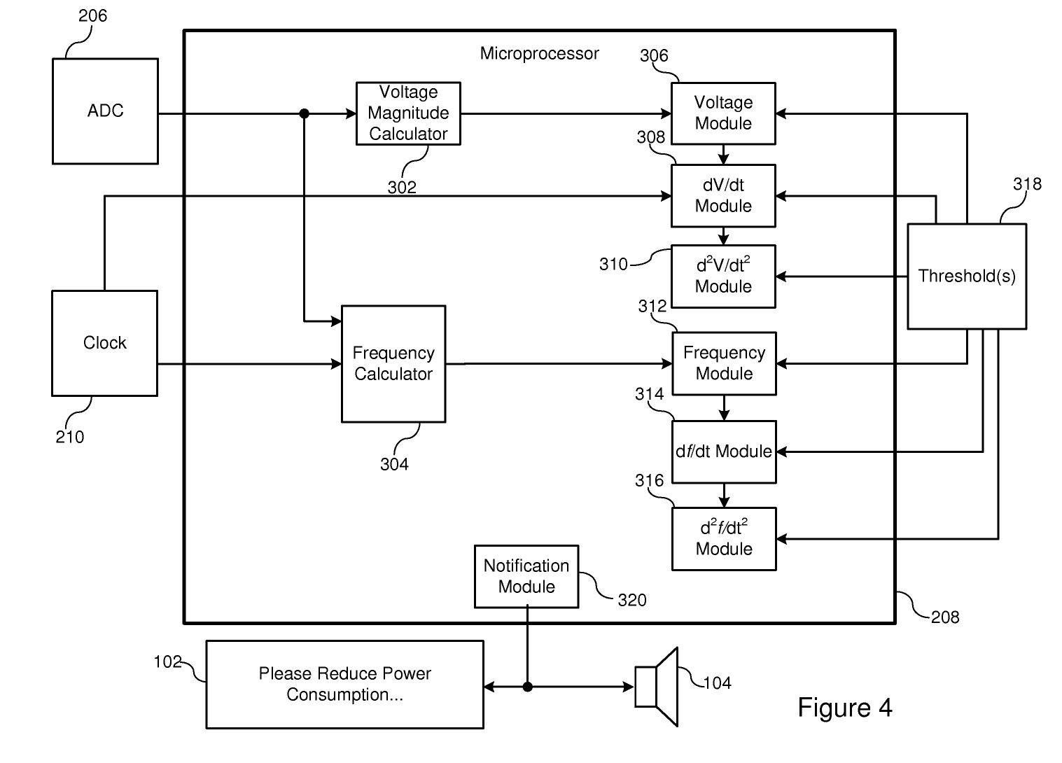

In an alternative embodiment illustrated in FIG. 4, several of the voltage and frequency functions use values calculated by other voltage and frequency functions, thus saving processor burden. The V values used in the Voltage Function 306 are made available to the

$$\frac{d V}{d t}$$

Function 308 for its calculations. The

$$\frac{d V}{d t}$$

values from the

$$\frac{d V}{d t}$$

Function 308 are made available to the

$$\frac{{d}^{2} V}{d {t}^{2}}$$

Function 310 for its calculations. Further, the frequency values used in the Frequency Function 312 are made available to the

$$\frac{d f}{d t}$$

Function 314, for its calculations, and the

$$\frac{d f}{d t}$$

values from the

$$\frac{d f}{d t}$$

Function 314 are made available to the

$$\frac{{d}^{2} f}{d {t}^{2}}$$

Function 316 for its calculations. Thus several of the calculations need not be performed in parallel by several of the blocks. Further, to the extent that a time signal is needed in the various functions, such signal may be available from the clock 210, the microprocessor 208, the voltage calculator 302, the frequency calculator 304, or from the various functions that communicate with the function that needs the time signal. For example, the

$$\frac{d {}^{2} f}{d {t}^{2}}$$

Function 316 may receive the time signal from the

$$\frac{d f}{d t}$$

function 314, from the frequency calculator 304, and/or from the clock 210.

As indicated above, the various voltage and frequency functions 306-316 are configured to provide an output to the Notification Function 320. The Notification function uses the outputs to decide if a notification should be given and which notification should be given. The Notification Function 320 enables the display 102 and/or the speaker 104 to give the appropriate notification. The Notification Function 320 may be configured to control the display 102 and/or the speaker 104 in giving the notification.

The Notification Function 320 may be configured to access a particular notification stored in the data storage unit 212 upon being signaled by one or more of the voltage and/or frequency functions of a particular power system condition. Further, the Notification Function 320 may be configured to record the time that the particular power system condition was detected (or, if a timer or oscillator is used, the passage of time since the detection of the power system condition) using the data storage unit 212 and further display the elapsed time since the detection of the power system condition as part of the notification.

For example, once the Notification Function 320 has received communication from one or more of the voltage and/or frequency monitoring functions that a particular power system condition is present; the Notification Function 320 may record a time stamped log entry in data storage unit 212, and retrieve the appropriate notification message. The Notification Function 320 will then send a command to the display 102 and/or speaker 104 that includes the notification to be given. The display 102 and/or speaker 104 will then give the appropriate notification.

One or more detected power system conditions from the voltage and frequency functions may contribute to whether and/or which notification should be given. That is, one or more of the voltage and frequency functions may provide signals to the Notification Function 320 to assert a notification or to assert a particular notification. The Notification Function 320 may include an algorithm for determining whether to assert a particular notification based on the signals provided by the voltage and frequency functions. In one example, the Notification Function 320 may be configured to give a single notification regardless of which voltage or frequency function has asserted a signal to provide notification. The Notification Function 320 may be configured to provide notification only if signals are asserted by more than one voltage or frequency function, and/or persist for longer than some predetermined amount of time. The Notification Function 320 may be configured to change the notification message depending on which voltage or frequency function asserts a signal.

The Notification Function 320 can access several prerecorded messages stored in the data storage unit 212, and choose from among the messages depending on the signals that are asserted by the voltage and/or frequency functions so that messages may be customized as mentioned above.

Further, though the thresholds function 318, the clock 210, and ADC 206 are illustrated outside of the microprocessor, all of these may be executed or included within the microprocessor. The thresholds used by the voltage and frequency functions may be generated by the individual voltage and frequency functions based on past calculations. For example, the various thresholds may calculate a running average of past measurements/calculations that do not exceed the then-existing threshold. This running average may be stored in the data storage unit and used as the threshold for that function. Accordingly, the thresholds may be dynamic. As mentioned above, the thresholds may be preset by the manufacturer, and/or adjustable by the consumer.

Further, the Notification Function 320 may be capable of accessing a particular message once the particular power system condition is no longer detected. For example, if the various voltage and frequency functions deassert, the Notification Function 320 may retrieve and cause to be displayed a message indicating that the power system has returned to normal.

FIGS. 5A and 5B illustrate logical configurations of various blocks and functions of the previous figures. Specifically, FIG. 5A illustrates a logic diagram 500 in which threshold values from the threshold function 318 are available to each of the voltage and frequency functions. The Voltage Function 306 receives V values from the voltage magnitude calculator and compares these V values against a threshold from the threshold function 318 using comparator C1. The output from comparator C1 is then available to OR block 502. Likewise, in the

$$\frac{d V}{d t}$$

Function 308, values of

$$\frac{d V}{d t}$$

are calculated (from V values from the Voltage Function 306) and compared against a threshold in comparator C2. The output from comparator C2 is then available to OR block 502. Further, in the

$$\frac{d {}^{2} V}{d {t}^{2}}$$

Function 310, values of

$$\frac{d {}^{2} V}{d {t}^{2}}$$

are calculated (from values of

$$\frac{d V}{d t}$$

from the

$$\frac{d V}{d t}$$

Function 308) and then compared against yet another threshold in comparator C3. The output from comparator C3 is then available to OR block 502.

As for the frequency functions, the frequency from the frequency calculator is available to the Frequency Function 312, which compares these values against a frequency threshold in comparator C4. Output from comparator C4 is available to OR block 502. The

$$\frac{d f}{d t}$$

Function 314 calculates values of

$$\frac{d f}{d t}$$

(using values of frequency from the Frequency Function 312) and compares them against

$$\frac{d f}{d t}$$

thresholds in comparator C5. Output from comparator C5 is available to OR block 502. Finally, the

$$\frac{d {}^{2} f}{d {t}^{2}}$$

Function 316 calculates values of

$$\frac{d {}^{2} f}{d {t}^{2}}$$

(from values of

$$\frac{d f}{d t}$$

from the

$$\frac{d f}{d t}$$

Function 314) and compares them against thresholds in comparator C6. Output from comparator C6 is available to OR block 502.

The OR block is within the Notification Function 320. In the configuration illustrated in FIG. 5A, the OR block issues an alarm if any of the outputs from any comparators C1-C6 are high.

As mentioned above, the Notification Function 320 may be configured to issue different alarms when different frequency and voltage functions indicate certain power system conditions. One example of this is illustrated in the logic diagram 501 of FIG. 5B. Here, the Notification Function 320 includes two separate OR blocks 504, 506. OR block 504 receives output from the various voltage functions 306, 308, 310, where OR block 506 receives output from the various frequency functions 312, 314, 316. If any of the outputs from the voltage functions 306, 308, 310 are high, then the Notification Function issues a voltage alarm as an input to AND block 524. If the voltage alarm is enabled 522, and a voltage alarm is given, then AND block 524 issues a high output to OR block 528. If any of the outputs from the frequency functions 312, 314, 316 are high, then the Notification Function issues a frequency alarm as an input to AND block 526. If the frequency alarm is enabled 520, and a frequency alarm is given, then AND block 524 issues a high output to OR block 528. OR block 528 then issues an alarm if the output from either AND block 524 or 526 are high. The enable voltage alarm 522 and enable frequency alarm 520 may be user inputs or settings.

The Notification Function 320 may be configured to issue an alarm only if combinations of the voltage and frequency functions indicate that a threshold has been breached. For example, the Notification Function 320 of FIG. 5B may be configured to only issue an alarm if outputs from both OR blocks 504 and 506 are high. One way to effect this is by enabling the frequency alarm 520 when the output from OR block 504 is high and enabling the voltage alarm 522 when the output from OR block 506 is high, and replacing the OR block 528 with an AND block.

In an example an alarm may issue only if both the frequency and voltage drop below thresholds. To effect this, the Enable Voltage Alarm 522 output is high only if the Voltage Function 306 indicates that the voltage falls below a threshold. The Enable Frequency Alarm 520 output is high only if the Frequency Function 312 indicates that the frequency falls below a threshold. Then replacing the OR block 528 with an AND block, an alarm will only issue if both the voltage and frequency fall below their respective thresholds.

Further embodiments are contemplated wherein various combinations of outputs from the various voltage and frequency functions are required for the Notification Function 320 to issue an alarm. Further, it is contemplated that various alarms could be given depending on the combination of outputs from the various voltage and frequency functions.

Various combinations of enable and threholds can be contrived to achieve desired notification.

Also as mentioned above, each of the various frequency and voltage functions may compare against multiple thresholds. FIG. 5C illustrates a portion of the logic diagram of either 5A or 5B where the voltage function 306 includes two comparators C1a and C1b. The thresholds function 318 outputs a first threshold of 118 V to comparator C1a and a second threshold of 117 V to comparator C1b. The comparators then compare the output from the voltage calculation function against the thresholds, and output the results to the notification function 320.

FIG. 5D illustrates another possible logic diagram of comparing a quantity against various thresholds, this diagram using one comparator instead of multiple comparators. The thresholds function 318 provides multiple (in this case two) thresholds to the voltage function 306 (T1 of 118 V and T2 or 117V). A threshold is compared against the measured voltage magnitude from the Voltage Magnitude Calculator 302 in comparator C1. The output of comparator C1 is communicated to the Notification Function 320. The output of comparator C1 also controls switch S1, which controls which threshold value is used by comparator C1. In this case, if the output of comparator is zero, then the switch defaults to threshold T1. Once the polarity of the output switches to high (the voltage has dropped below threshold T1), the switch changes position such that the comparator C1 evaluates the voltage magnitude against threshold T2. Again, if the output of comparator C1 is zero (the voltage is above threshold T2), the switch changes to the default position allowing comparison against threshold T1. If the output of comparator continues to be high (the voltage is below both thresholds T1 and T2), then the switch continues in the same position, allowing comparison against threshold T2. As a result, if the voltage magnitude holds above both thresholds, the output of comparator C1 is zero. If the voltage magnitude is below both thresholds, the output of comparator C1 is high. If the voltage magnitude is between thresholds T1 and T2, then the output of comparator C1 switches between high and zero with each comparison. Thus, the output of comparator C1 may be used by the Notification Function 320 to determine if the voltage magnitude is above both thresholds, between the thresholds, or falls below both thresholds. Similar logical arrangements to FIGS. 5C and 5D may be used for comparison against several thresholds in any of the voltage and/or frequency functions.

IV. Method of Notifying Consumers of Electric Power

Also disclosed herein is a method of providing a notification to a consumer to reduce electric power consumption. The method uses the system and apparatus as described above to detect a power system condition that may be improved by a reduction in load on the power system, and to notify a consumer to reduce power consumption. The consumer is then better informed to decide to act to reduce power consumption. The apparatus, systems, and methods herein disclosed further may benefit the consumer in reducing electric cost to the consumer. Electric power utilities often are required to purchase electric power at higher rates during high-load power system conditions, which may result in higher electric costs to the consumer. This is due to the electric power utility passing on the increased cost either during the high-load condition, or based on the time of electric use. By giving the consumer notification that such power system conditions exist, the consumer is then able to decide to reduce power consumption based on the given information, and thus avoid paying the higher cost of electricity.

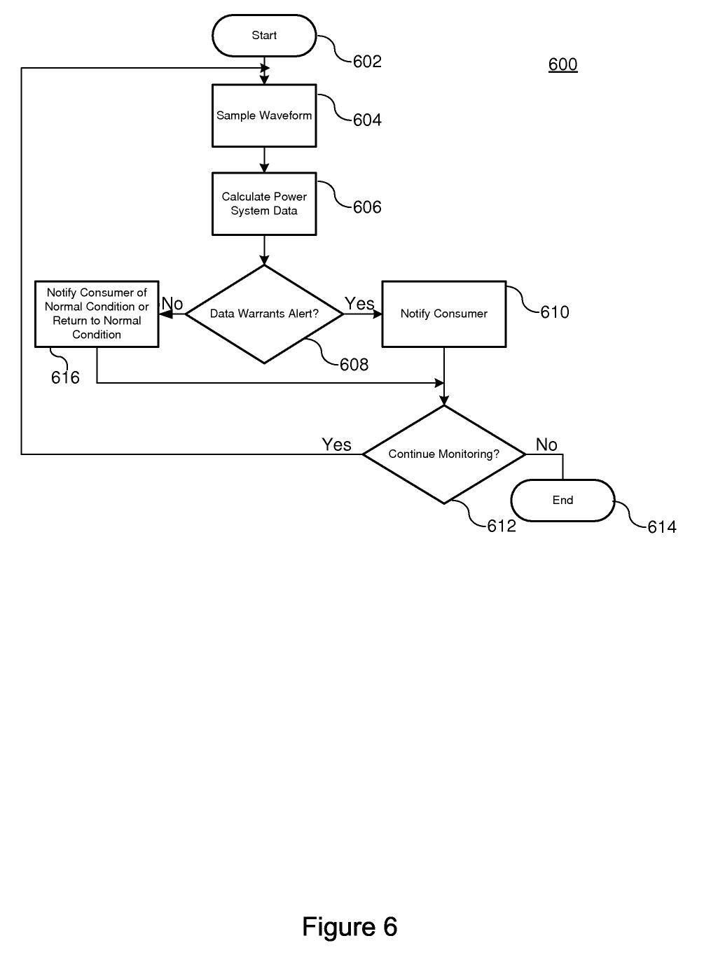

FIG. 6 illustrates a flow chart of a method 600 of providing such notification to a consumer. The method of FIG. 6 may operate on the notification device described above. The method 600 starts 602 when either the notification device is turned on or plugged into the outlet. The notification device samples the waveform 604 present on the electric power system via the power outlet. Using the various functions described above, the notification device calculates power system data 606 such as voltage, change in voltage, rate of change of voltage, frequency, change in frequency, rate of change in frequency, and combinations thereof. The power system data that is calculated is then compared against thresholds to determine if an alert should be issued 608. If not, the method notifies the consumer that the power system has a normal condition or (if the data previously warranted an alert) that the power system has returned to a normal condition in block 616. If the method is to continue monitoring 612, then the method returns to sampling the waveform 604. Otherwise, the method ends 614. In 608 if an alert should be issued, the method alerts the consumer 610 by providing a message using the display and/or the speaker. If the method is to continue monitoring the electric power system 612, then the method returns to sampling the waveform in step 604. Otherwise, the method ends 614.

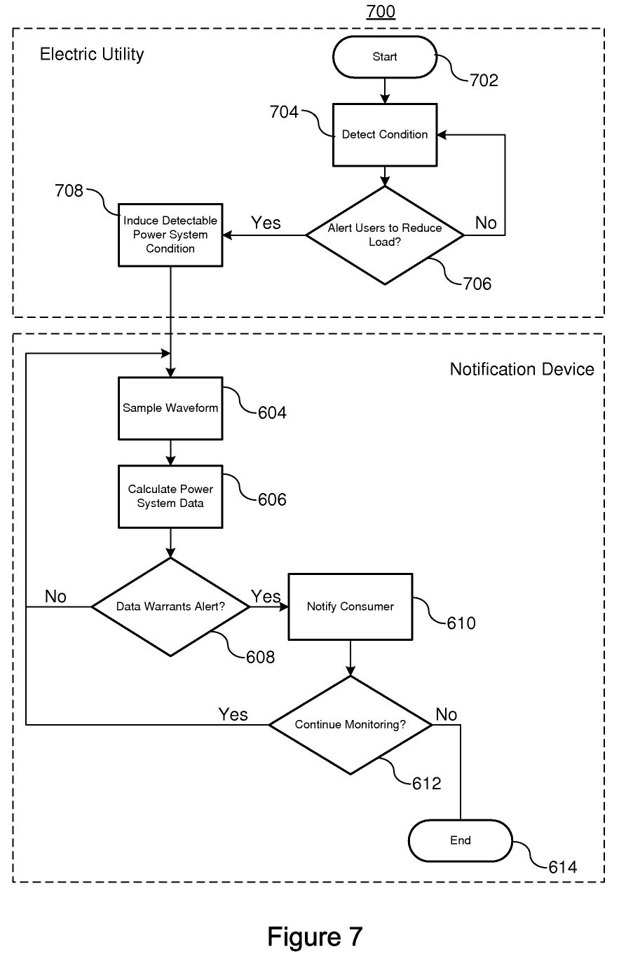

FIG. 7 illustrates a flow chart of a method 700 where the electric power utility is able to send a message to consumers to decrease power consumption by inducing a power system condition. The induced power system condition may be calculated to cause the notification devices to assert a notification, but not so severe that electric power distribution is significantly effected. For example, the notification devices may be configured such that a small or short-lived change in the voltage where the rate of change is high but the actual change is relatively low would trigger an alert, but such would not significantly affect the electric power system. Thus, if the electric power utility has determined that a reduction in load would be beneficial to the electric power system, it could induce such a condition to notify consumers to reduce power consumption without interrupting power delivery.

The illustrated method 700 starts 702 with the electric power utility detecting a condition 704 that may be improved by reducing load. Such a condition may correspond with an aspect of the operation of the power system such as high loading, a power swing, out-of-step condition, scheduled maintenance of power system equipment, failure of equipment, upcoming predictable high-load events or times of day, and the like. Upon detecting such a condition 704, the decision is made whether to alert consumers to reduce power consumption 706. If not, then the method returns to detecting a condition 704. However, if an applicable condition is detected, then a detectable power system condition is induced 708. The induced condition is detectable by the notification devices, and that would trigger the notification devices to notify consumers to reduce power consumption.

The method then follows the method as described in FIG. 6. The notification device samples the waveform 604 present on the electric power system via the power outlet. Using the various functions described above, the notification device calculates power system data 606 such as voltage, change in voltage, rate of change of voltage, frequency, change in frequency, rate of change in frequency, and combinations thereof. The power system data that is calculated is then compared against thresholds to determine if an alert should be issued 608. If not, then the method returns to sampling the waveform 604. However, if an alert should be issued, the method alerts the consumer 610 by providing a message using the display and/or the speaker. If the method is to continue monitoring the electric power system 612, then the method returns to sampling the waveform in step 604. Otherwise, the method ends 614.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. An apparatus for communicating to a consumer an electric power system condition for which a decrease in electric power consumption would benefit the consumer or utility, comprising:
an acquisition circuit coupled to an electric power system for sampling an electric power signal and generating power system data using the sampled signal;
a logic circuit coupled to the acquisition circuit for receiving and comparing the power system data against a threshold and generating a power system condition signal based on the power system data and the threshold; and,
a notification circuit coupled to the logic circuit and configured to generate a notification to the consumer depending on the power system condition signal.

2. The apparatus of claim 1, wherein the acquisition circuit includes a voltage acquisition circuit, and the power system data comprises a power system voltage.

3. The apparatus of claim 2, wherein the threshold comprises a predetermined voltage value.

4. The apparatus of claim 1, wherein the acquisition circuit comprises:
a voltage acquisition circuit; and,
a calculation circuit coupled to the voltage acquisition circuit for calculating a change of voltage; and,
wherein the power system data comprises a change of voltage.

5. The apparatus of claim 1, wherein the acquisition circuit comprises:
a voltage acquisition circuit; and,
a calculation circuit coupled to the voltage acquisition circuit for calculating a rate of change of voltage; and,
wherein the power system data comprises a rate of change of voltage.

6. The apparatus of claim 5, wherein the threshold comprises a predetermined rate of change of voltage.

7. The apparatus of claim 1, wherein the acquisition circuit includes a frequency acquisition circuit configured to determine a power system frequency, and the power system data comprises power system frequency.

8. The apparatus of claim 7, wherein the threshold comprises a predetermined frequency value.

9. The apparatus of claim 7, wherein the threshold comprises a value based on past values of power system frequency.

10. The apparatus of claim 1, wherein the acquisition circuit comprises:
a frequency acquisition circuit configured to determine a power system frequency;
a calculation circuit in communication with the frequency acquisition circuit configured to calculate a rate of change of frequency; and,
wherein the power system data comprises a rate of change of frequency.

11. The apparatus of claim 10, wherein the threshold comprises a predetermined frequency value.

12. The apparatus of claim 10, wherein the threshold comprises a value based on past values of power system frequency.

13. The apparatus of claim 1, further comprising a display coupled to the notification circuit for displaying the notification.

14. The apparatus of claim 1, further comprising a speaker coupled to the notification circuit for providing audible notification.

15. The apparatus of claim 1, wherein the threshold is based on past power system data.

16. The apparatus of claim 1, wherein:
the acquisition circuit includes a voltage acquisition circuit configured to determine a power system voltage and a frequency acquisition circuit configured to determine a power system frequency;
the power system data comprises power system voltage and power system frequency; and,
the notification circuit generates a notification if both the power system voltage falls below a voltage threshold and the power system frequency falls below a frequency threshold.

17. The apparatus of claim 1, wherein the notification comprises notification of a normal power system condition when the power system condition signal indicates that the power system is operating within normal conditions.

18. A system for communicating to a consumer an electric power system condition for which a decrease in electric power consumption would benefit the consumer or utility based on a consumer connection to an electric power distribution system, the system comprising:
a notification device coupled to the consumer connection including:
an acquisition circuit coupled to the electric power system via the consumer connection for sampling an electric power signal available to the consumer and generating power system data using the sampled signal;
a logic circuit coupled to the acquisition circuit for receiving and comparing the power system data against a threshold and provide a power system condition signal; and,
a notification circuit coupled to the logic circuit for generating a notification to the consumer depending on the power system condition signal; and
a switch in communication with one of the devices configured to decrease the amount of electric power consumed by the device when switched by the consumer.

19. The system of claim 18, wherein the acquisition circuit includes a voltage acquisition circuit, and the power system data comprises a power system voltage.

20. The system of claim 19, wherein the threshold comprises a predetermined voltage value.

21. The system of claim 18, wherein the acquisition circuit comprises:
a voltage acquisition circuit; and
a calculation circuit coupled to the voltage acquisition circuit for calculating a change in voltage; and,
wherein the power system data comprises change of voltage.

22. The system of claim 18, wherein the acquisition circuit comprises:
a voltage acquisition circuit; and,
a calculation circuit coupled to the voltage acquisition circuit for calculating a rate of change of voltage; and,
wherein the power system data comprises a rate of change of voltage.

23. The system of claim 22, wherein the threshold comprises a predetermined rate of change of voltage.

24. The system of claim 18, wherein the acquisition circuit includes a frequency acquisition circuit for determining a power system frequency, and the power system data comprises power system frequency.

25. The system of claim 24, wherein the threshold comprises a predetermined frequency value.

26. The system of claim 24, wherein the threshold comprises a value based on past values of power system frequency.

27. The system of claim 18, wherein the acquisition circuit comprises:
a frequency acquisition circuit for determining a power system frequency;
a calculation circuit coupled to the frequency acquisition circuit for calculating a rate of change of frequency; and,
wherein the power system data comprises a rate of change of frequency.

28. The system of claim 27, wherein the threshold comprises a predetermined frequency value.

29. The system of claim 27, wherein the threshold comprises a value based on past values of power system frequency.

30. The system of claim 18, further comprising a display coupled to the notification circuit, configured to display the notification.

31. The system of claim 18, further comprising a speaker coupled to the notification circuit, configured to provide audible notification.

32. The system of claim 18, wherein the threshold is based on past power system data.

33. The system of claim 18, wherein,
the acquisition circuit includes a voltage acquisition circuit configured to determine a power system voltage and a frequency acquisition circuit configured to determine a power system frequency;
the power system data comprises power system voltage and power system frequency; and,
the notification circuit generates a notification if both the power system voltage falls below a voltage threshold and the power system frequency falls below a frequency threshold.

34. The system of claim 18, wherein the notification comprises notification of a normal power system condition when the power system condition signal indicates that the power system is operating within normal conditions.

35. A method for notifying an electric power customer of a power system condition warranting a derrease of electric power consumption, comprising the steps of:
sampling an electric power signal present on a source of electric power available to the consumer to provide power signal samples;
calculating power system data using the power signal samples;
comparing the power system data against a threshold;
generating a signal depending on an output from the comparing step; and
generating a notification depending on the signal generated.

36. The method of claim 35, further comprising the step of inducing a power system condition that will result in the generation of the notification.

37. The method of claim 36, wherein the step of inducing comprises one selected from the group consisting of: decreasing frequency, increasing frequency, decreasing voltage, increasing voltage, increasing a rate of change of frequency and increasing a rate of change of voltage.

38. The method of claim 35, wherein the step of sampling comprises sampling electric power system voltage values, and the step of calculating comprises calculating voltage magnitude.

39. The method of claim 38, wherein the threshold comprises a predetermined voltage value.

40. The method of claim 38, wherein the step of calculating further comprises calculating a rate of change of voltage and the threshold comprises a predetermined change in voltage value.

41. The method of claim 35, wherein:
the step of sampling comprises sampling electric power system voltage values; and,
the step of calculating comprises calculating a rate of change of voltage; and,
wherein the power system data comprises a rate of change of voltage.

42. The method of claim 41, wherein the threshold comprises a predetermined rate of change of voltage.

43. The method of claim 35, wherein the step of calculating comprises calculating a power system frequency, and the power system data comprises power system frequency.

44. The method of claim 43, wherein the threshold comprises a predetermined frequency value.

45. The method of claim 43, wherein the threshold comprises a value based on past values of power system frequency.

46. The method of claim 35, wherein the acquisition circuit comprises:
a frequency acquisition circuit for determining a power system frequency;
a calculation circuit coupled to the frequency acquisition circuit for calculating a rate of change of frequency; and,
wherein the power system data comprises a rate of change of frequency.

47. The method of claim 46, wherein the threshold comprises a predetermined frequency value.

48. The method of claim 46, wherein the threshold comprises a value based on past values of power system frequency.

49. The method of claim 35, further comprising a display coupled to the notification circuit for displaying the notification.

50. The method of claim 35, further comprising a speaker coupled to the notification circuit for providing audible notification.

51. The method of claim 35, wherein the threshold is based on past power system data.

52. The method of claim 35, wherein:
the step of calculating comprises calculating a power system voltage and calculating a power system frequency;
the step of comparing comprises comparing the power system voltage against a voltage threshold and comparing the power system frequency against a frequency threshold; and
the step of generating a signal comprises generating a signal if the power system voltage falls below the voltage threshold and the power system frequency falls below the frequency threshold.

53. The method of claim 35, wherein the notification comprises notification of a normal power system condition when the signal indicates a normal power system condition.
